(19) United States
(12) Patent Application Publication
(10) Pub. No.: US 2023/0238579 A1
(43) Pub. Date: Jul. 27, 2023

(54) NON-AQUEOUS ELECTROLYTE SECONDARY BATTERY

(71) Applicant: MURATA MANUFACTURING CO., LTD., Kyoto (JP)

(72) Inventor: Takuju HASHIMOTO, Kyoto (JP)

(21) Appl. No.: 18/127,452

(22) Filed: Mar. 28, 2023

Related U.S. Application Data
(63) Continuation of application No. PCT/JP2021/035643, filed on Sep. 28, 2021.

(30) Foreign Application Priority Data
Oct. 2, 2020 (JP) 2020-167935

(51) Int. Cl. H01M 10/0567; H01M 4/62; H01M 10/0569

(52) U.S. Cl. CPC H01M 10/0567; H01M 4/622; H01M 10/0569; H01M 2300/004

(57) ABSTRACT

Provided is a non-aqueous electrolyte secondary battery capable of achieving both load characteristics and cycle characteristics. The non-aqueous electrolyte secondary battery includes a positive electrode, a negative electrode, and a non-aqueous electrolytic solution. The negative electrode includes a negative electrode active material layer including acrylonitrile-styrene-butadiene rubber. The non-aqueous electrolytic solution includes a propionic acid ester, a halogenated cyclic carbonic acid ester, and at least one of predetermined cyclic sulfuric acid anhydrides. A content of the acrylonitrile-styrene-butadiene rubber in the negative electrode active material layer is 0.5 mass% or more and 2.0 mass% or less.

### CROSS REFERENCE TO RELATED APPLICATIONS

The present application is a continuation of PCT patent application no. PCT/JP2021/035643 filed on Sep. 28, 2021, which claims priority to Japanese patent application no. JP 2020-167935, filed on Oct. 2, 2020, the entire contents of which are incorporated herein by reference.

### BACKGROUND

The present application relates to a non-aqueous electrolyte secondary battery.

In recent years, a non-aqueous electrolyte secondary battery using acrylonitrile-butadiene-styrene rubber or styrene-butadiene rubber (SBR) as a negative electrode binder has been studied.

For example, a lithium ion secondary battery is described as including a negative electrode containing acrylonitrile-butadiene-styrene rubber as a water-dispersible binder and an electrolytic solution containing fluoroethylene carbonate (FEC) and ethyl propionate, in which a content of the fluoroethylene carbonate (FEC) with respect to the whole electrolytic solution is 10 to 15 wt%.

A non-aqueous electrolytic solution secondary battery is described as including a negative electrode containing styrene-butadiene rubber (SBR) as a binder and an electrolytic solution containing ethyl propionate.

### SUMMARY

The present application relates to a non-aqueous electrolyte secondary battery.

However, in the secondary batteries described in the Background, it is difficult to achieve both load characteristics and cycle characteristics.

The present application relates to providing, in an embodiment, a non-aqueous electrolyte secondary battery capable of achieving both load characteristics and cycle characteristics.

In an embodiment, the present application provides a non-aqueous electrolyte secondary battery including:
a positive electrode;
a negative electrode; and
a non-aqueous electrolytic solution, in which
the negative electrode includes a negative electrode active material layer containing acrylonitrile-styrene-butadiene rubber,
the non-aqueous electrolytic solution contains a propionic acid ester, a halogenated cyclic carbonic acid ester, and at least one of cyclic sulfuric acid anhydrides represented by Formulas (1) and (2) below, and
a content of the acrylonitrile-styrene-butadiene rubber in the negative electrode active material layer is 0.5 mass% or more and 2.0 mass% or less,

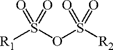

wherein R₁ and R₂ are each independently a divalent hydrocarbon group or divalent halogenated hydrocarbon group that may have a substituent, and R₁ and R₂ are bonded to each other,

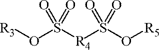

wherein R₃ and R₅ are each independently a divalent hydrocarbon group or divalent halogenated hydrocarbon group that may have a substituent, R₄ is a divalent hydrocarbon group or divalent halogenated hydrocarbon group that may have a substituent, and R₃ and R₅ are bonded to each other.

According to the present application, in an embodiment, both load characteristics and cycle characteristics can be achieved.

### BRIEF DESCRIPTION OF THE FIGURES

FIG. 1 is an exploded perspective view illustrating an example of a configuration of a non-aqueous electrolyte secondary battery according to an embodiment of the present application.

FIG. 2 is a sectional view taken along line II-II of FIG. 1.

FIG. 3 is a block diagram illustrating an example of a configuration of an electronic device according to an embodiment of the present application.

### DETAILED DESCRIPTION

One or more embodiments will be described below in further detail including with reference to the figures.

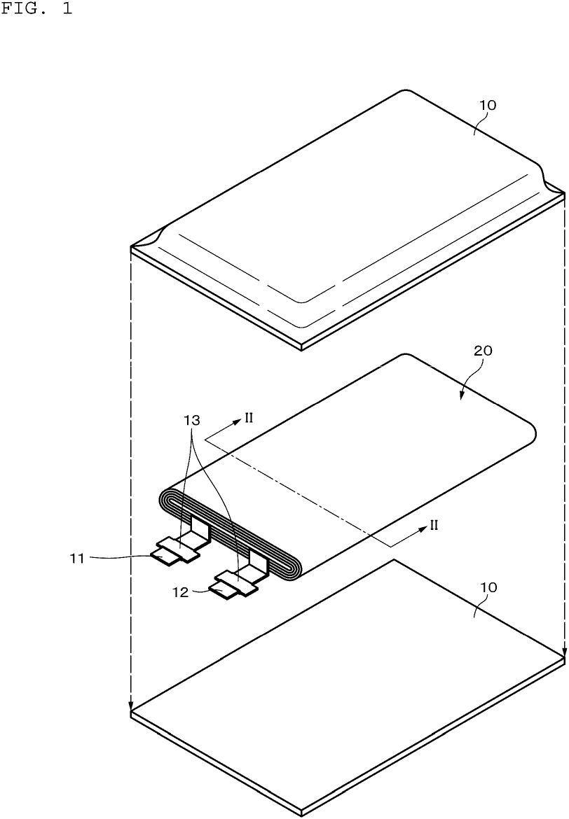

FIG. 1 illustrates an example of a configuration of a non-aqueous electrolyte secondary battery (hereinafter, simply referred to as “battery”) according to an embodiment of the present application. The battery is a so-called laminate type battery that is obtained by housing, in a film-shaped exterior material 10, an electrode body 20 having a positive electrode lead 11 and a negative electrode lead 12 attached thereto and that is capable of attaining the reduction in size, weight, and thickness.

The positive electrode lead 11 and the negative electrode lead 12 are each led out from the inside of the exterior material 10 toward the outside, for example, in the same direction. Each of the positive electrode lead 11 and the negative electrode lead 12 is composed of, for example, a metal material such as Al, Cu, Ni, or stainless steel, and has a thin plate shape or a mesh shape.

The exterior material 10 is composed of, for example, a rectangular aluminum laminate film obtained by bonding a nylon film, an aluminum foil, and a polyethylene film in this order. For example, the exterior material 10 is configured such that the polyethylene film side and the electrode body 20 face each other, and outer edge portions thereof are in close contact with each other by fusion or an adhesive. An adhesive film 13 for suppressing entry of outside air is inserted between the exterior material 10 and the positive electrode lead 11 and the negative electrode lead 12. The adhesive film 13 is composed of a material having adhesion to the positive electrode lead 11 and the negative electrode lead 12, for example, a polyolefin resin such as polyethylene, polypropylene, modified polyethylene, or modified polypropylene.

The exterior material 10 may be composed of a laminate film having another structure, a polymer film such as polypropylene, or a metal film, instead of the aluminum laminate film described above. Alternatively, the exterior material 10 may be composed of a laminate film in which a polymer film is laminated on one surface or both surfaces of an aluminum film as a core material.

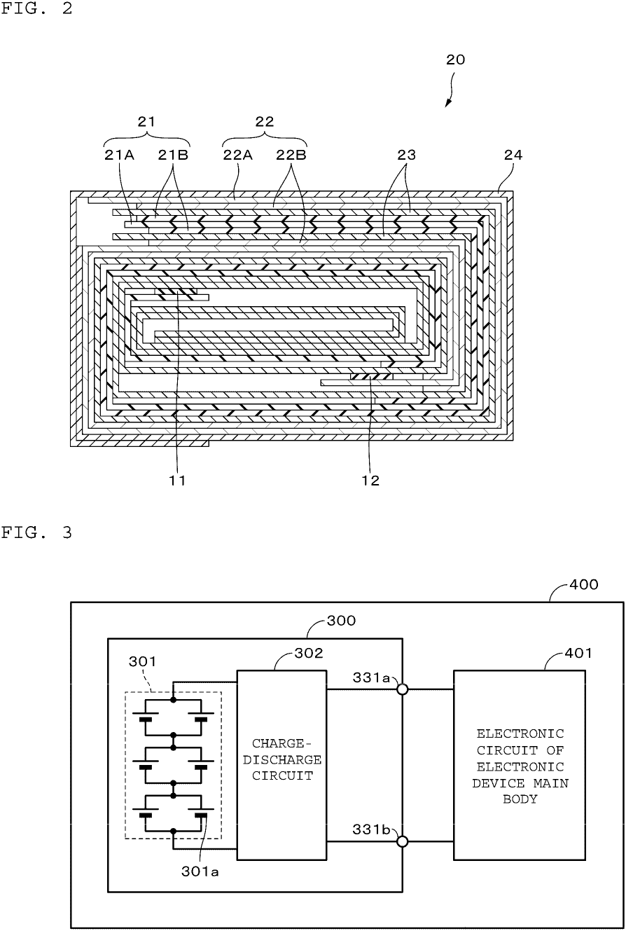

FIG. 2 is a sectional view of the electrode body 20 illustrated in FIG. 1 taken along the line II-II. The electrode body 20 is a wound electrode body having a configuration obtained by stacking a positive electrode 21 and a negative electrode 22 both having an elongated shape with a separator 23 having an elongated shape interposed between the positive electrode and the negative electrode, and winding the stacked electrodes and separator in a flattened and swirling form, and an outermost peripheral portion of the electrode body is protected by a protection tape 24. Into the exterior material 10, an electrolytic solution as an electrolyte is injected for impregnation of the positive electrode 21, the negative electrode 22, and the separator 23.

Hereinafter, the positive electrode 21, the negative electrode 22, the separator 23, and the electrolytic solution constituting the battery will be sequentially described.

The positive electrode 21 includes, for example, a positive electrode current collector 21A and a positive electrode active material layer 21B provided on both sides of the positive electrode current collector 21A. The positive electrode current collector 21A is configured with, for example, metal foil such as an aluminum foil, a nickel foil, or a stainless-steel foil. The positive electrode current collector 21A may have a plate shape or a net shape. The positive electrode lead 11 may be formed by extending a part of a periphery of the positive electrode current collector 21A. The positive electrode active material layer 21B contains one or two or more kinds of positive electrode active materials capable of occluding and releasing lithium. The positive electrode active material layer 21B may further contain at least one selected from the group consisting of a binder or a conductive auxiliary if necessary.

As the positive electrode active material capable of occluding and releasing lithium, a lithium-containing compound, for example, lithium oxide, lithium phosphorus oxide, lithium sulfide, or an intercalation compound containing lithium is suitable, and two or more of these may be used in mixture. In order to increase the energy density, a lithium-containing compound which contains lithium, a transition metal element, and oxygen is preferable. Examples of such a lithium-containing compound include a lithium composite oxide having a layered rock-salt structure represented by Formula (A), and a lithium composite phosphate having an olivine structure represented by Formula (B). The lithium-containing compound more preferably contains, as a transition metal element, at least one selected from the group consisting of Co, Ni, Mn, and Fe. Examples of such a lithium-containing compound include: a lithium composite oxide having a layered rock-salt structure represented by Formula (C), Formula (D), or Formula (E); a lithium composite oxide having a spinel structure represented by Formula (F); and a lithium composite phosphate having an olivine structure represented by Formula (G), and specifically include LiNi_{0.50}Co_{0.20}Mn_{0.30}O₂, LiCoO₂, LiNiO₂, LiNiₐCo₁₋ₐO₂ (0 < a < 1), LiMn₂O₄, and LiFePO₄.

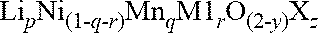

(In Formula (A), M1 represents at least one of elements selected from Groups 2 to 15 excluding Ni and Mn. X represents at least one selected from the group consisting of Group 16 elements except for oxygen and Group 17 elements. p, q, y, and z are values within the ranges of 0 ≤ p ≤ 1.5, 0 ≤ q ≤ 1.0, 0 ≤ r ≤ 1.0, -0.10 ≤ y ≤ 0.20, and 0 ≤ z ≤ 0.2.)

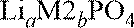

(In Formula (B), M2 represents at least one of elements selected from Group 2 to Group 15. a and b represent values within the ranges of 0 ≤ a ≤ 2.0 and 0.5 ≤ b ≤ 2.0.)

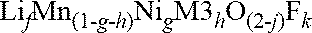

(In Formula (C), M3 represents at least one selected from the group consisting of Co, Mg, Al, B, Ti, V, Cr, Fe, Cu, Zn, Zr, Mo, Sn, Ca, Sr, and W. f, g, h, j, and k are values within ranges of 0.8 ≤ f ≤ 1.2, 0 < g < 0.5, 0 ≤ h ≤ 0.5, g + h < 1, -0.1 ≤ j ≤ 0.2, and 0 ≤ k ≤ 0.1. The composition of lithium differs depending on the state of charge and discharge, and the value of f represents a value in the fully discharged state.)

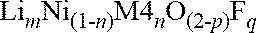

(In Formula (D), M4 represents at least one selected from the group consisting of Co, Mn, Mg, Al, B, Ti, V, Cr, Fe, Cu, Zn, Mo, Sn, Ca, Sr, and W. m, n, p, and q are values within ranges of 0.8 ≤ m ≤ 1.2, 0.005 ≤ n ≤ 0.5, -0.1 ≤ p ≤ 0.2, and 0 ≤ q ≤ 0.1. The composition of lithium differs depending on the state of charge and discharge, and the value of m represents a value in the fully discharged state.)

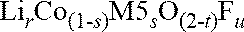

(In Formula (E), M5 represents at least one selected from the group consisting of Ni, Mn, Mg, Al, B, Ti, V, Cr, Fe, Cu, Zn, Mo, Sn, Ca, Sr, and W. r, s, t, and u are values within ranges of 0.8 ≤ r ≤ 1.2, 0 ≤ s < 0.5, -0.1 ≤ t ≤ 0.2, and 0 ≤ u ≤ 0.1. The composition of lithium differs depending on the state of charge and discharge, and the value of r represents a value in the fully discharged state. )

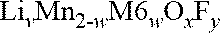

(In Formula (F), M6 represents at least one selected from the group consisting of Co, Ni, Mg, Al, B, Ti, V, Cr, Fe, Cu, Zn, Mo, Sn, Ca, Sr, and W. v, w, x, and y are values within ranges of 0.9 ≤ v ≤ 1.1, 0 ≤ w ≤ 0.6, 3.7 ≤ x ≤ 4.1, and 0 ≤ y ≤ 0.1. The composition of lithium differs depending on the state of charge and discharge, and the value of v represents a value in the fully discharged state.)

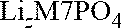

(In Formula (G), M7 represents at least one selected from the group consisting of Co, Mg, Fe, Ni, Mg, Al, B, Ti, V, Nb, Cu, Zn, Mo, Ca, Sr, W, and Zr. z is a value within a range of 0.9 ≤ z ≤ 1.1. The composition of lithium differs depending on the state of charge and discharge, and the value of z represents a value in the fully discharged state.)

In addition to these, an inorganic compound including no lithium, such as MnO₂, V₂O₅, V₆O₁₃, NiS, or MoS, can also be used as the positive electrode active material capable of occluding and releasing lithium.

The positive electrode active material capable of occluding and releasing lithium may be one other than the above. Two or more of the positive electrode active materials exemplified above may be mixed in any combination.

As a binder, for example, at least one selected from the group consisting of resin materials such as polyvinylidene fluoride, polytetrafluoroethylene, polyacrylonitrile, styrene-butadiene rubber, and carboxymethyl cellulose, copolymers mainly containing these resin materials, and the like is used.

As a conductive auxiliary, for example, at least one carbon material selected from the group consisting of, for example, graphite, carbon fiber, carbon black, acetylene black, Ketjen black, carbon nanotube, and graphene can be used. The conductive auxiliary may be any material exhibiting conductivity and is not limited to the carbon materials. For example, a metal material or a conductive polymer material may be used as the conductive auxiliary. Examples of the shape of the conductive auxiliary include a granular shape, a scaly shape, a hollow shape, a needle shape, and a tubular shape, but the shape is not limited to these shapes.

The negative electrode 22 includes, for example, a negative electrode current collector 22A and a negative electrode active material layer 22B provided on both sides of the negative electrode current collector 22A. The negative electrode current collector 22A is composed of, for example, a metal foil such as a copper foil, a nickel foil, or a stainless-steel foil. The negative electrode current collector 22A may have a plate shape or a net shape. The negative electrode lead 12 may be formed by extending a part of a periphery of the negative electrode current collector 22A. The negative electrode active material layer 22B contains one or two or more kinds of negative electrode active materials capable of occluding and releasing lithium, and a binder. The negative electrode active material layer 22B may further contain at least one selected from the group consisting of a thickener or a conductive auxiliary if necessary.

In this battery, it is preferable that the electrochemical equivalent of the negative electrode 22 or the negative electrode active material is larger than the electrochemical equivalent of the positive electrode 21, and theoretically, lithium metal is not deposited on the negative electrode 22 during charging.

Examples of the negative electrode active material include carbon materials such as non-graphitizable carbon, graphitizable carbon, graphite, pyrolytic carbons, cokes, glassy carbons, organic polymer compound fired bodies, carbon fibers, or activated carbon. Of these, examples of the cokes include pitch coke, needle coke, and petroleum coke. The organic polymer compound fired body refers to a carbonized product obtained by firing a polymer material such as phenol resin or furan resin at an appropriate temperature, and some organic polymer compound fired bodies are classified as non-graphitizable carbon or graphitizable carbon. These carbon materials are preferable since the variation in the crystal structure occurred during charging and discharging is very small, and a high charge and discharge capacity as well as good cycle characteristics can be obtained. In particular, graphite is preferable since it has a large electrochemical equivalent and can obtain high energy density. Non-graphitizable carbon is preferable since excellent cycle characteristics can be attained. Those having a low charge and discharge potential, specifically those having a charge and discharge potential close to that of lithium metal are preferable since it is possible to easily realize a high energy density of the battery.

Examples of other negative electrode active materials capable of increasing the capacity also include materials including at least one selected from the group consisting of a metal element and a metalloid element as a constituent element (for example, an alloy, a compound, or a mixture). This is because a high energy density can be obtained by using such a material. In particular, the use of such a material in combination with a carbon material is more preferable since a high energy density and excellent cycle characteristics can be obtained at the same time. In the present application, the alloy includes an alloy including one or more metal elements and one or more metalloid elements in addition to an alloy including two or more metal elements. The alloy may contain a nonmetallic element. The compositional structure of the alloy includes a solid solution, a eutectic (eutectic mixture), an intermetallic compound, and a material in which two or more kinds of these coexist.

Examples of such a negative electrode active material include a metal element or a metalloid element capable of forming an alloy with lithium. Specific examples thereof include Mg, B, Al, Ti, Ga, In, Si, Ge, Sn, Pb, Bi, Cd, Ag, Zn, Hf, Zr, Y, Pd, and Pt. These may be crystalline or amorphous.

The negative electrode active material preferably contains a metal element or metalloid element of the group 4B in the short periodic table as a constituent element and more preferably contains at least either of Si or Sn as a constituent element. This is because Si and Sn are high in ability of occluding and releasing lithium to enable the battery to obtain a high energy density. Examples of such a negative electrode active material include: a simple substance, an alloy, or a compound of Si; a simple substance, an alloy or a compound of Sn; and a material having one or two or more thereof in at least a part thereof.

Examples of the alloy of Si include alloys including at least one selected from the group consisting of Sn, Ni, Cu, Fe, Co, Mn, Zn, In, Ag, Ti, Ge, Bi, Sb, Nb, Mo, Al, P, Ga, and Cr as the second constituent element other than Si. Examples of the alloy of Sn include alloys including at least one selected from the group consisting of Si, Ni, Cu, Fe, Co, Mn, Zn, In, Ag, Ti, Ge, Bi, Sb, Nb, Mo, Al, P, Ga, and Cr as the second constituent element other than Sn.

Examples of the compound of Sn or the compound of Si include compounds including O or C as a constituent element. These compounds may include the second constituent element described above.

Particularly, the Sn-based negative electrode active material preferably includes Co, Sn, and C as constituent elements, and has a low crystallinity or an amorphous structure.

Examples of other negative electrode active materials include metal oxides or polymer compounds capable of occluding and releasing lithium. Examples of the metal oxide include lithium titanium oxide including Li and Ti, such as lithium titanate (Li₄Ti₅O₁₂), iron oxide, ruthenium oxide, and molybdenum oxide. Examples of the polymer compound include polyacetylene, polyaniline, and polypyrrole.

As the binder, acrylonitrile-styrene-butadiene rubber is used. The acrylonitrile-styrene-butadiene rubber has a higher binding force than an ordinary binder such as SBR. Therefore, the content of the binder in the negative electrode active material layer 22B can be reduced.

The content of the acrylonitrile-styrene-butadiene rubber in the negative electrode active material layer 22B is preferably 0.5 mass% or more and 2.0 mass% or less. When the content of the acrylonitrile-styrene-butadiene rubber is 0.5 mass% or more, high cycle characteristics can be obtained. On the other hand, when the content of the acrylonitrile-styrene-butadiene rubber is 2.0 mass% or less, high load characteristics can be obtained.

The content of the acrylonitrile-styrene-butadiene rubber is measured as follows. First, the negative electrode 22 is taken out from the battery, washed with dimethyl carbonate (DMC), and dried. Next, several to several tens mg of the sample is heated to 600° C. in an air atmosphere at a temperature rise rate of 1 to 5° C./min by a thermogravimetry-differential thermal analyzer (TG-DTA, Rigaku Thermo plus TG8120 manufactured by Rigaku Corporation), and the content of the acrylonitrile-styrene-butadiene rubber in the negative electrode active material layer 22B is determined from the reduced weight during the heating.

The thickener is used for adjusting the viscosity of an electrode slurry. Examples of the thickener include cellulose-based polymers such as carboxymethyl cellulose (CMC) .

As the conductive auxiliary, for example, conductive auxiliaries similar to those for the positive electrode active material layer 21B can be used.

The separator 23 separates the positive electrode 21 and the negative electrode 22, prevents a short circuit due to contact with both electrodes each other, and allows permeation of lithium ions. The separator 23 is composed of, for example, a porous film consisting of polytetrafluoroethylene, a polyolefin resin (for example, polypropylene (PP) or polyethylene (PE)), an acrylic resin, a styrene resin, a polyester resin, a nylon resin, or a resin obtained by blending these resins, and may have a structure in which two or more of these porous films are laminated.

Of these, a porous film consisting of polyolefin is preferable because of having an excellent short-circuit preventing effect and allowing improvement in the safety of the battery by a shutdown effect. In particular, polyethylene enables to obtain a shutdown effect within a range of 100° C. or higher and 160° C. or lower and is also excellent in electrochemical stability, and hence is preferable as a material constituting the separator 23. Among them, low-density polyethylene, high-density polyethylene, or linear polyethylene is suitably used because they have an appropriate fusing temperature and are easily available. In addition, a material obtained by copolymerizing or blending a resin having chemical stability with polyethylene or polypropylene can be used. Alternatively, the porous film may have a structure of three or more layers in which a polypropylene layer, a polyethylene layer, and a polypropylene layer are sequentially laminated. For example, it is desirable to have a three-layer structure of PP/PE/PP, and the mass ratio [mass%] of PP and PE is PP : PE = 60 : 40 to 75 : 25. Alternatively, from the viewpoint of cost, the single layer substrate having 100 mass% of PP or 100 mass% of PE can also be used. The method for producing the separator 23 may be wet or dry.

As the separator 23, nonwoven fabric may be used. As the fibers constituting the nonwoven fabric, at least one selected from the group consisting of aramid fibers, glass fibers, polyolefin fibers, polyethylene terephthalate (PET) fibers, nylon fibers, and the like can be used.

The separator 23 may have a configuration including a substrate and a surface layer provided on one or both surfaces of the substrate. The surface layer includes inorganic particles having insulation properties and a resin material that binds the inorganic particles to the surface of the substrate and binds the inorganic particles to each other. This resin material may have a three-dimensional network structure in which, for example, a plurality of fibrils are connected by fibrillation. In this case, the inorganic particles may be supported on the resin material having the three-dimensional network structure. The resin material may bind the surface of the substrate and the inorganic particles without being fibrillated. In this case, higher binding properties can be obtained. By providing the surface layer on one or both surfaces of the substrate as described above, the oxidation resistance, the heat resistance, the mechanical strength, and the like of the separator 23 can be improved.

The electrolytic solution is a so-called non-aqueous electrolytic solution, and contains a non-aqueous solvent, an electrolyte salt, a cyclic sulfuric acid anhydride, and a halogenated cyclic carbonic acid ester. The battery may include an electrolyte layer containing an electrolytic solution and a polymer compound serving as a holding body for holding this electrolytic solution, instead of the electrolytic solution. In this case, the electrolyte layer may be in a gel state.

The non-aqueous solvent contains at least one propionic acid ester. From the viewpoint of the ionic conductivity of the electrolytic solution and the swellability of the acrylonitrile-styrene-butadiene rubber, the number of carbon atoms of the propionic acid ester is preferably 4 or more and 7 or less. As the propionic acid ester, it is preferable to use at least one selected from the group consisting of methyl propionate, ethyl propionate, propyl propionate, and butyl propionate.

From the viewpoint of improving cycle characteristics, the non-aqueous solvent preferably further contains at least one cyclic carbonic acid ester. As the cyclic carbonic acid ester, at least one selected from the group consisting of ethylene carbonate (EC), propylene carbonate (PC), and the like is preferably used, and both ethylene carbonate and propylene carbonate are particularly preferably contained.

From the viewpoint of improving ion conductivity, the non-aqueous solvent preferably further contains at least one chain carbonic acid ester. As the chain carbonic acid ester, at least one selected from the group consisting of diethyl carbonate, dimethyl carbonate, ethyl methyl carbonate, methyl propyl carbonate, and the like is preferably used.

The non-aqueous solvent may contain at least one selected from the group consisting of 2,4-difluoroanisole, vinylene carbonate, and the like. This is because 2,4-difluoroanisole can further improve discharge capacity, and vinylene carbonate can further improve cycle characteristics.

In addition to these, the non-aqueous solvent may contain at least one selected from the group consisting of butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethyl sulfoxide, trimethyl phosphate, and the like.

As the electrolyte salt, for example, at least one lithium salt is used. Examples of the lithium salt include at least one selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalate borate, LiBr, and the like. Of these, LiPF₆ is preferable because high ion conductivity can be obtained and cycle characteristics can be further improved.

As the cyclic sulfuric acid anhydride, at least one of cyclic sulfuric acid anhydrides represented by Formulas (1) and (2) below is used. Hereinafter, the cyclic sulfuric acid anhydride represented by Formula (1) is referred to as the cyclic sulfuric acid anhydride (1), and the cyclic sulfuric acid anhydride represented by Formula (2) is referred to as the cyclic sulfuric acid anhydride (2). When the cyclic sulfuric acid anhydride (1) and the cyclic sulfuric acid anhydride (2) are collectively referred to without distinction, these are simply referred to as cyclic sulfuric acid anhydrides.

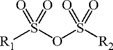

wherein R₁ and R₂ are each independently a divalent hydrocarbon group or divalent halogenated hydrocarbon group that may have a substituent, and R₁ and R₂ are bonded to each other,

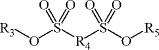

wherein R₃ and R₅ are each independently a divalent hydrocarbon group or divalent halogenated hydrocarbon group that may have a substituent, R₄ is a divalent hydrocarbon group or divalent halogenated hydrocarbon group that may have a substituent, and R₃ and R₅ are bonded to each other.

The cyclic sulfuric acid anhydride (1) is preferably a cyclic sulfuric acid anhydride represented by Formula (1A) below.

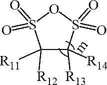

(In Formula (1A), m is an integer of 0 or more and 3 or less, and R₁₁, R₁₂, R₁₃, and R₁₄ are each independently a hydrocarbon group that may have a substituent, a halogen group, or a hydrogen group.)

The cyclic sulfuric acid anhydride (2) is preferably a cyclic sulfuric acid anhydride represented by Formula (2A) below.

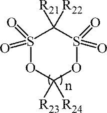

(In Formula (2A|_{[A1]}), n is an integer of 0 or more and 1 or less, and R₂₁, R₂₂, R₂₃, and R₂₄ are each independently a hydrocarbon group that may have a substituent, a halogen group, or a hydrogen group.)

In Formulas (1), (2), (1A), and (2A), the hydrocarbon group is a generic term for groups composed of carbon (C) and hydrogen (H), and may be a saturated hydrocarbon group, or an unsaturated hydrocarbon group. Herein, the saturated hydrocarbon group is an aliphatic hydrocarbon group having no carbon-carbon multiple bond, and the unsaturated hydrocarbon group is an aliphatic hydrocarbon group having a carbon-carbon multiple bond (carbon-carbon double bond or carbon-carbon triple bond). The hydrocarbon group may be linear, branched with one or two or more side chains, or cyclic with one or two or more rings but the hydrocarbon group is preferably linear since the chemical stability of the electrolytic solution is further improved.

Examples of the substituent that the hydrocarbon group may have include a halogen group and an alkyl group having a halogen group.

When Formulas (1A) and (2A) include a hydrocarbon group, the number of carbon atoms included in the hydrocarbon group is preferably 1 or more and 5 or less, and more preferably 1 or more and 3 or less.

When the Formulas (1), (2), (1A), and (2A) include a halogen group, the halogen group is, for example, a fluorine group (-F), a chlorine group (-Cl), a bromine group (-Br) or an iodine group (-I), and preferably a fluorine group (-F).

From the viewpoint of the chemical stability of the electrolytic solution, in Formula (1A), all of R₁₁, R₁₂, R₁₃, and R₁₄ are preferably hydrogen groups. Similarly, from the viewpoint of the chemical stability of the electrolytic solution, in Formula (2A), all of R₂₁, R₂₂, R₂₃, and R₂₄ are preferably hydrogen groups.

As the cyclic sulfuric acid anhydride represented by Formula (1A), specifically, for example, at least one selected from the group consisting of cyclic sulfuric acid anhydrides represented by Formulas (1-1) to (1-9) can be used.

### Chemical Formula 3

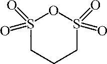

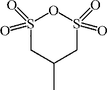

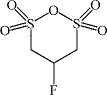 [SMILES: O=S1(=O)CC(F)CS(=O)(=O)O1]

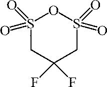 [SMILES: O=S1(=O)CC(F)(F)CS(=O)(=O)O1]

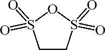

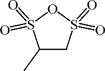

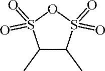

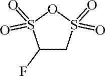

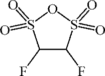 [SMILES: O=S1(=O)OS(=O)(=O)C(F)C1F]

As the cyclic sulfuric acid anhydride represented by Formula (2A), specifically, for example, at least one selected from the group consisting of cyclic sulfuric acid anhydrides represented by Formulas (2-1) to (2-6) can be used.

### Chemical Formula 4

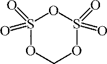

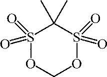

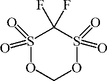 [SMILES: O=S1(=O)OCOS(=O)(=O)C1(F)F]

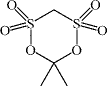

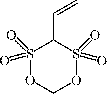

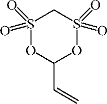

The content of the cyclic sulfuric acid anhydride in the non-aqueous electrolytic solution is preferably 0.1 mass% or more and 1.0 mass% or less and more preferably 0.5 mass% or more and 1.0 mass% or less, from the viewpoint of improving both load characteristics and cycle characteristics.

The content of the cyclic sulfuric acid anhydride is determined by extracting an electrolytic solution component from a battery using DMC, a heavy solvent, or the like, and then performing Gas Chromatograph-Mass Spectrometry (GC-MS) measurement and Inductively Coupled Plasma (ICP) measurement on the obtained extract.

The halogenated carbonic acid ester refers to a cyclic carbonic acid ester including one or two or more halogens as constituent elements. As the halogenated cyclic carbonic acid ester, for example, at least one halogenated carbonic acid ester represented by Formula (3) below is used.

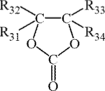

(In Formula (3), R₃₁ to R₃₄ are each independently a hydrogen group, a halogen group, a monovalent hydrocarbon group, or a monovalent halogenated hydrocarbon group, and at least one of R₃₁ to R₃₄ is a halogen group or a monovalent halogenated hydrocarbon group.)

Examples of the monovalent hydrocarbon group include an alkyl group. Examples of the monovalent halogenated hydrocarbon group include a halogenalkyl group. The kind of halogen is not particularly limited, but among them, fluorine (F), chlorine (Cl), or bromine (Br) is preferable, and fluorine is more preferable.

Specific examples of the halogenated cyclic carbonic acid ester represented by Formula (3) include at least one selected from the group consisting of 4-fluoro-1,3-dioxolan-2-one (FEC), 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1, 3-oxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2 -one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, 4-fluoro-4-methyl-1,3-dioxolan-2-one, and the like. This halogenated cyclic carbonic acid ester also includes geometric isomers. For example, as 4,5-difluoro-1,3-dioxolan-2-one, a trans isomer is preferred to a cis isomer. This is because a trans isomer can be easily procured and a high effect is attained.

The content of the halogenated cyclic carbonic acid ester in the non-aqueous electrolytic solution is preferably 2.0 mass% or more and 6.0 mass% or less, from the viewpoint of improving both load characteristics and cycle characteristics and improving high-temperature storage characteristics.

The content of the halogenated cyclic carbonic acid ester is determined in the same manner as the method for measuring the content of the cyclic sulfuric acid anhydride.

In the battery having the above-described configuration, when charging is performed, for example, lithium ions are released from the positive electrode active material layer 21B and occluded in the negative electrode active material layer 22B with the electrolytic solution interposed therebetween. In addition, when discharging is performed, for example, lithium ions are released from the negative electrode active material layer 22B and occluded in the positive electrode active material layer 21B with the electrolytic solution interposed therebetween.

Next, an example of a method for manufacturing the battery according to an embodiment of the present application will be described.

The positive electrode 21 is prepared as follows. First, for example, a positive electrode active material, a binder, and a conductive auxiliary are mixed together to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to the positive electrode current collector 21A, the solvent is dried, compression molding is performed using a roll pressing machine or the like to form the positive electrode active material layer 21B, and the positive electrode 21 is thus obtained.

The negative electrode 22 is prepared as follows. First, for example, a negative electrode active material and a binder are mixed together to prepare a negative electrode mixture, and this negative electrode mixture is dispersed in a solvent such as N-methyl-2-pyrrolidone to prepare a paste-like negative electrode mixture slurry. Next, this negative electrode mixture slurry is applied to the negative electrode current collector 22A, the solvent is dried, compression molding is performed using a roll pressing machine or the like to form the negative electrode active material layer 22B, and the negative electrode 22 is thus obtained.

The wound electrode body 20 is produced as follows. First, the positive electrode lead 11 is attached to one end portion of the positive electrode current collector 21A by welding and the negative electrode lead 12 is attached to one end portion of the negative electrode current collector 22A by welding. Then, the positive electrode 21 and the negative electrode 22 are wound around a flat winding core with the separator 23 interposed therebetween and wound many times in the longitudinal direction, and then the protection tape 24 is adhered to the outermost peripheral portion to obtain the electrode body 20.

The electrode body 20 is sealed by the exterior material 10 as follows. First, the electrode body 20 is sandwiched between the exterior materials 10, the outer peripheral edge portions excluding that of one side are thermally fusion-bonded to form a bag shape, and the electrode body 20 is thus housed inside the exterior material 10. At that time, the adhesive film 13 is inserted between the positive electrode lead 11, the negative electrode lead 12, and the exterior material 10. The adhesive film 13 may be attached in advance to each of the positive electrode lead 11 and the negative electrode lead 12. Next, an electrolytic solution is injected into the exterior material 10 from the side having not been fusion-bonded, and the side having not been fusion-bonded is then thermally fusion-bonded in a vacuum atmosphere for hermetical sealing. The battery illustrated in FIGS. 1 and 2 is thus obtained.

The acrylonitrile-styrene-butadiene rubber can obtain a high binding force with a content smaller than that of ordinary SBR. Therefore, when the acrylonitrile-styrene-butadiene rubber is used as a binder, the content of the binder can be reduced, so that an increase in resistance due to the active material coating of the binder can be suppressed, and high load characteristics can be obtained. However, in the case of using a propionic acid ester as the non-aqueous solvent of the non-aqueous electrolytic solution, since it is necessary to impart a protective function to the surface of the negative electrode to suppress reductive decomposition of the propionic acid ester on the negative electrode, it is difficult to reduce the addition amount of the acrylonitrile-styrene-butadiene rubber as a binder.

As a method for solving the above problems, it is conceivable to contain a halogenated cyclic carbonic acid ester such as FEC, as a negative electrode solid electrolyte interphase (SEI) forming material, in the non-aqueous electrolytic solution. However, in this case, it is necessary to contain a large amount of the halogenated cyclic carbonic acid ester in the non-aqueous electrolytic solution. When a large amount of the halogenated cyclic carbonic acid ester is contained in the non-aqueous electrolytic solution as described above, the formation amount of SEI derived from the halogenated cyclic carbonic acid ester increases, which causes an increase in resistance and gas generation during high-temperature storage.

In the battery according to an embodiment of the present application, (1) the negative electrode active material layer 22B contains an acrylonitrile-styrene-butadiene rubber in an amount of 0.5 mass% or more and 2.0 mass% or less, (2) the non-aqueous electrolytic solution contains a propionic acid ester, and (3) the non-aqueous electrolytic solution further contains a halogenated cyclic carbonic acid ester, and at least one of a cyclic sulfuric acid anhydride (1) and a cyclic sulfuric acid anhydride (2). By combining these (1) to (3), it is possible to achieve both load characteristics and cycle characteristics while reducing the contents of the acrylonitrile-styrene-butadiene rubber and the halogenated cyclic carbonic acid ester. The mechanism thereof is that the negative electrode 22 forms a film in which a cyclic sulfuric acid anhydride is combined with acrylonitrile contained in acrylonitrile-styrene-butadiene rubber at a potential nobler than a halogenated cyclic carbonic acid ester such as FEC. As a result, the consumption amount of the halogenated cyclic carbonic acid ester at the time of initial charging can be reduced, and a high negative electrode protective function can be exhibited when the content of the halogenated cyclic carbonic acid ester is reduced. Since the consumption amount of the halogenated cyclic carbonic acid ester is reduced, it is possible to obtain high cycle characteristics while reducing the addition amount of the halogenated cyclic carbonic acid ester which is originally gradually consumed during cycle charging and discharging, and it is possible to suppress deterioration of high-temperature storage characteristics which is a problem of the halogenated cyclic carbonic acid ester. The amount of the halogenated cyclic carbonic acid ester contributing to the negative electrode protective function can be reduced by the SEI formation of the cyclic sulfuric acid anhydride, the resistance of the negative electrode 22 can be reduced, and an increase in resistance due to the reductive decomposition product of the propionic acid ester can be suppressed, so that high load characteristics can be obtained.

In an embodiment, an electronic device including a battery described herein according to an embodiment will be described.

FIG. 3 illustrates an example of a configuration of an electronic device 400 according to an embodiment of the present application. The electronic device 400 includes an electronic circuit 401 of an electronic device main body, and a battery pack 300. The battery pack 300 is electrically connected to the electronic circuit 401 with a positive electrode terminal 331a and a negative electrode terminal 331b interposed therebetween. The electronic device 400 may have a configuration in which the battery pack 300 is freely attached and detached.

Examples of the electronic device 400 include laptop personal computers, tablet computers, mobile phones (for example, smartphones), personal digital assistants (PDA), display devices (Liquid Crystal Display (LCD), Electro Luminescence (EL) display, electronic paper and the like), imaging devices (for example, digital still cameras, digital video cameras and the like), audio devices (for example, portable audio players), game consoles, cordless phones, e-books, electronic dictionaries, radios, headphones, navigation systems, memory cards, pacemakers, hearing aids, electric power tools, electric shavers, refrigerators, air conditioners, TVs, stereos, water heaters, microwave ovens, dishwashers, washing machines, dryers, lighting equipment, toys, medical equipment, and robots, but the electronic device 400 is not limited thereto.

The electronic circuit 401 includes, for example, a central processing unit (CPU), a peripheral logic unit, an interface unit, a storage unit, and the like and controls the overall electronic device 400.

The battery pack 300 includes an assembled battery 301 and a charge-discharge circuit 302. The battery pack 300 may further include an exterior material (not illustrated) which houses the assembled battery 301 and the charge-discharge circuit 302, if necessary.

The assembled battery 301 is configured by connecting a plurality of secondary batteries 301a in series and/or in parallel. The plurality of secondary batteries 301a are connected, for example, in n parallel m series (n and m are positive integers). FIG. 3 illustrates an example in which six secondary batteries 301a are connected in 2 parallel 3 series (2P3S). As the secondary battery 301a, the battery according to an embodiment described herein is used.

A case in which the battery pack 300 includes the assembled battery 301 including the plurality of secondary batteries 301a is described, but a configuration in which the battery pack 300 includes one secondary battery 301a instead of the assembled battery 301 may be adopted.

The charge-discharge circuit 302 is a control unit which controls charging and discharging of the assembled battery 301. Specifically, during charging, the charge-discharge circuit 302 controls charging to the assembled battery 301. On the other hand, during discharging (that is, when the electronic device 400 is used), the charge-discharge circuit 302 controls discharging of the electronic device 400.

A case composed of, for example, a metal, a polymer resin, or a composite material thereof can be used as the exterior material. Examples of the composite material include a laminate in which a metal layer and a polymer resin layer are laminated.

### EXAMPLES

Hereinafter, the present application will be specifically described with reference to Examples according to an embodiment; however, the present application is not limited only to these Examples.

In the following Examples and Comparative Examples, the content of the acrylonitrile-styrene-butadiene rubber in the positive electrode active material layer of the finished battery, the content of the cyclic sulfuric acid anhydride in the electrolytic solution of the finished battery, and the content of the fluoroethylene carbonate (FEC) in the electrolytic solution of the finished battery were determined by the measurement method described herein according to an embodiment.

### Examples 1 to 4 and Comparative Examples 1 and 2

### Producing Positive Electrode

A positive electrode was produced as follows. A positive electrode mixture was obtained by mixing a positive electrode active material, polyvinylidene fluoride (PVdF (homopolymer of vinylidene fluoride) as a binder, and carbon black as a conductive auxiliary, and this positive electrode mixture was dispersed in an organic solvent (N-methyl-2-pyrrolidone: NMP) to prepare a paste-like positive electrode mixture slurry. Subsequently, the positive electrode mixture slurry was applied to a positive electrode current collector (aluminum foil) with a coater and dried to form a positive electrode active material layer. Finally, the positive electrode active material layer was compression-molded to a predetermined mixture density using a pressing machine.

### Producing Negative Electrode

A negative electrode was produced as follows. First, a negative electrode mixture was obtained by mixing artificial graphite powder as a negative electrode active material, acrylonitrile-styrene-butadiene rubber as a binder, and carboxymethyl cellulose (CMC) as a thickener, and this negative electrode mixture was dispersed in an organic solvent (N-methyl-2-pyrrolidone: NMP) to prepare a paste-like negative electrode mixture slurry. At this time, the mixing ratio of the artificial graphite powder and the acrylonitrile-styrene-butadiene rubber was changed for each of Examples 1 to 4 and Comparative Examples 1 and 2, so that the content of the acrylonitrile-styrene-butadiene rubber in the negative electrode active material layer of the finished battery was a value shown in Table 1. The mixing ratio of the carboxymethyl cellulose was constant regardless of Examples 1 to 4 and Comparative Examples 1 and 2. Subsequently, the negative electrode mixture slurry was applied to a negative electrode current collector (copper foil) with a coater and dried. Finally, the negative electrode active material layer was compression-molded by a pressing machine.

### Preparing Electrolytic Solution

An electrolytic solution was prepared as follows. First, ethylene carbonate (EC), propylene carbonate (PC), and ethyl propionate were mixed at a predetermined volume ratio to prepare a mixed solvent. Subsequently, the cyclic sulfuric acid anhydride represented by Formula (1-1) and fluoroethylene carbonate (FEC) were dissolved, and lithium hexafluorophosphate (LiPF₆) as an electrolyte salt was dissolved in this mixed solvent so as to be 1 mol/l, thereby preparing an electrolytic solution. At this time, the blending amounts of the cyclic sulfuric acid anhydride and the FEC were adjusted so that the content of the cyclic sulfuric acid anhydride in the electrolytic solution of the finished battery was 0.5 mass% and the content of the FEC was 4.0%.

### Producing Laminate Type Battery

A laminate type battery was produced as follows. First, an aluminum positive electrode lead was welded to the positive electrode current collector, and a copper negative electrode lead was welded to the negative electrode current collector. Subsequently, the positive electrode and the negative electrode were brought into close contact with each other with a microporous polyethylene film interposed therebetween and then wound in the longitudinal direction, and a protection tape was attached to the outermost peripheral portion to produce a flat-shaped wound electrode body. Next, this wound electrode body was loaded in an exterior material whose three sides were thermally fusion-bonded but whose one side was not thermally fusion-bonded to allow the exterior material to have an opening. As the exterior material, a moistureproof aluminum laminate film in which a 25 µm thick nylon film, a 40 µm thick aluminum foil, and a 30 µm thick polypropylene film were laminated in this order from the outermost layer was used. Thereafter, the electrolytic solution was injected through the opening of the exterior material, and the remaining one side of the exterior material was thermally fusion-bonded under reduced pressure to hermetically seal the wound electrode body. The intended laminate type battery was thus obtained.

### Comparative Examples 3 to 6

Laminate type batteries were obtained in the same manner as in Examples 1, 2, and 4 and Comparative Example 2, except that styrene-butadiene rubber (SBR) was used as a binder in the step of producing a negative electrode.

### Comparative Example 7

A laminate type battery was obtained in the same manner as in Example 2, except that diethyl carbonate (DEC) was used instead of the propionic acid ester in the step of preparing an electrolytic solution.

### Comparative Example 8

A laminate type battery was obtained in the same manner as Example 2, except that no FEC was blended in the mixed solvent in the step of preparing an electrolytic solution.

### Comparative Example 9

A laminate type battery was obtained in the same manner as Example 2, except that no cyclic sulfuric acid anhydride was blended in the mixed solvent in the step of preparing an electrolytic solution.

### Examples 5 to 8

Laminate type batteries were obtained in the same manner as in Example 2, except that the blending amount of the cyclic sulfuric acid anhydride with respect to the mixed solvent was changed for each of Examples 5 to 8 in the step of preparing an electrolytic solution so that the content of the cyclic sulfuric acid anhydride in the electrolytic solution of the finished battery was a value shown in Table 2.

### Examples 9 to 12

Laminate type batteries were obtained in the same manner as in Example 2, except that the blending amount of the cyclic sulfuric acid anhydride with respect to the mixed solvent was changed for each of Examples 9 to 12 in the step of preparing an electrolytic solution so that the content of the FEC in the electrolytic solution of the finished battery was a value shown in Table 3.

### Examples 13 and 26

Laminate type batteries were obtained in the same manner as in Example 2, except that cyclic sulfuric acid anhydrides represented by Formulas (1-2) to (1-9) and Formulas (2-1) to (2-6) were used as shown in Table 4 in the step of preparing an electrolytic solution.

### Examples 27 to 38 and Comparative Examples 10 to 12

Laminate type batteries were obtained in the same manner as in Example 2, except that non-aqueous solvents shown in Table 5 were added instead of the ethyl propionate in the step of preparing an electrolytic solution.

### [Evaluation of Battery Characteristics]

Load characteristics and cycle characteristics of the laminate type batteries of Examples 1 to 38 and Comparative Examples 1 to 12 obtained as described above were evaluated as follows. High-temperature storage characteristics of the laminate type batteries of Examples 2, 9 to 12, and 27 to 38 and Comparative Examples 10 to 12 were also evaluated as follows.

### Load Characteristics

Load characteristics were evaluated as follows. First, the battery was charged and discharged in an ambient temperature environment (temperature = 23° C.), thereby measuring the discharge capacity (discharge capacity before load discharging). During charging, constant current charging was performed at a current of 0.1 C until the voltage reached 4.2 V, and then constant voltage charging was performed at a voltage of 4.4 V until the current reached 0.05 C. During discharging, constant current discharge was performed at a current of 0.1 C until the voltage reached 3.0 V. Subsequently, the discharge capacity (discharge capacity after load discharging) was measured again by charging and discharging the battery under the same charging and discharging conditions except that the discharge current was changed to 1.0 C. Finally, the load characteristics were determined by the following equation.

$$\begin{matrix}\text{Load characteristics} \left[\%\right] \text{=} \left(\text{discharge capacity after}\right) \\ \left(\text{load discharging} / \text{discharge capacity before load discharging}\right) \\ \times 100\end{matrix}$$

The term “0.1 C” refers to a current value for fully discharging the battery capacity (theoretical capacity) in 10 hours, the term “0.05 C” refers to a current value for fully discharging the battery capacity (theoretical capacity) in 20 hours, and the term “1.0 C” refers to a current value for fully discharging the battery capacity (theoretical capacity) in 1 hour.

### Cycle Characteristics

Cycle characteristics were evaluated as follows. First, the battery was charged and discharged in an ambient temperature environment (temperature = 23° C.), thereby measuring the discharge capacity (discharge capacity before cycle). The charging and discharging conditions were set to the same conditions as in the case of examining the load characteristics (charging and discharging conditions of the first cycle). Subsequently, the battery was repeatedly charged and discharged until the total number of cycles reached 500 cycles to measure the discharge capacity (discharge capacity after cycle) again. The charging and discharging conditions were set to the same charging and discharging conditions as the charging and discharging conditions of the first cycle. Finally, the cycle characteristics were determined by the following equation.

$$\begin{matrix}\text{Cycle characteristics} \left[\%\right] \text{=} \left(\text{discharge capacity after}\right) \\ \left(\text{cycle} / \text{discharge capacity before cycle}\right) \times 100\end{matrix}$$

### High-Temperature Storage Characteristics

High-temperature storage characteristics were evaluated as follows. First, the thickness (thickness before storage) of the battery was measured in an ambient temperature environment (temperature = 23° C.). Subsequently, the battery was charged, and then the battery in a charged state was stored in a thermostatic bath (temperature = 60° C.) (storage time = 14 days). The charging conditions were the same as those in the method for evaluating load characteristics. Subsequently, the thickness (thickness after storage) of the battery was measured again in the thermostatic bath. Finally, the high-temperature storage characteristics were determined by the following equation.

$$\begin{matrix}\text{High-temperature storage characteristics} \left[\%\right] \text{=} \\ \left(\text{difference in thickness before and after storage} / \text{thickness}\right) \\ \left(\text{before storage}\right) \times 100\end{matrix}$$

Table 1 shows the configurations and evaluation results of the batteries of Examples 1 to 4 and Comparative Examples 1 to 9.

TABLE 1

| | Binder | | Electrolytic solution | | | | Load characteristics [%] | Cycle characteristics [%] |
|---|---|---|---|---|---|---|---|---|
| | Type | Content [mass%] | Propionic acid ester | FEC Content [mass%] | Cyclic sulfuric acidanhydride | Cyclic sulfuric acid anhydride Content [mass%] | | |
| Example 1 | Acrylonitrile-styrene-butadiene rubber | 0.5 | Ethyl propionate | 4.0 | (1-1) | 0.5 | 81 | 77 |
| Example 2 | Acrylonitrile-styrene-butadiene rubber | 1.0 | Ethyl propionate | 4.0 | (1-1) | 0.5 | 80 | 82 |
| Example 3 | Acrylonitrile-styrene-butadiene rubber | 1.5 | Ethyl propionate | 4.0 | (1-1) | 0.5 | 80 | 80 |
| Example 4 | Acrylonitrile-styrene-butadiene rubber | 2.0 | Ethyl propionate | 4.0 | (1-1) | 0.5 | 79 | 79 |
| Comparative Example 1 | Acrylonitrile-styrene-butadiene rubber | 0.3 | Ethyl propionate | 4.0 | (1-1) | 0.5 | 81 | 58 |
| Comparative Example 2 | Acrylonitrile-styrene-butadiene rubber | 3.0 | Ethyl propionate | 4.0 | (1-1) | 0.5 | 62 | 72 |
| Comparative Example 3 | Styrene-butadiene rubber | 0.5 | Ethyl propionate | 4.0 | (1-1) | 0.5 | 70 | 59 |
| Comparative Example 4 | Styrene-butadiene rubber | 1.0 | Ethyl propionate | 4.0 | (1-1) | 0.5 | 65 | 66 |
| Comparative Example 5 | Styrene-butadiene rubber | 2.0 | Ethyl propionate | 4.0 | (1-1) | 0.5 | 62 | 68 |
| Comparative Example 6 | Styrene-butadiene rubber | 3.0 | Ethyl propionate | 4.0 | (1-1) | 0.5 | 57 | 65 |
| Comparative Example 7 | Acrylonitrile-styrene-butadiene rubber | 1.0 | DEC | 4.0 | (1-1) | 0.5 | 55 | 71 |
| Comparative Example 8 | Acrylonitrile-styrene-butadiene rubber | 1.0 | Ethyl propionate | - | (1-1) | 0.5 | 71 | 59 |
| Comparative Example 9 | Acrylonitrile-styrene-butadiene rubber | 1.0 | Ethyl propionate | 4.0 | - | - | 69 | 70 |

Table 2 shows the configurations and evaluation results of the batteries of Examples 2 and 5 to 8 and Comparative Example 9.

TABLE 2

| | Binder | | Electrolytic solution | | | | Load characteristics [%] | Cycle characteristics [%] |
|---|---|---|---|---|---|---|---|---|
| | Type | Content [mass%] | Propionic acid ester | FEC Content [mass%] | Cyclic sulfuric acid anhydride | Cyclic sulfuric acid anhydride Content [mass%] | | |
| Example 2 | Acrylonitrile-styrene-butadiene rubber | 1.0 | Ethyl propionate | 4.0 | (1-1) | 0.5 | 80 | 82 |
| Example 5 | Acrylonitrile-styrene-butadiene rubber | 1.0 | Ethyl propionate | 4.0 | (1-1) | 0.1 | 78 | 78 |
| Example 6 | Acrylonitrile-styrene-butadiene rubber | 1.0 | Ethyl propionate | 4.0 | (1-1) | 1.0 | 79 | 80 |
| Example 7 | Acrylonitrile-styrene-butadiene rubber | 1.0 | Ethyl propionate | 4.0 | (1-1) | 0.05 | 76 | 77 |
| Example 8 | Acrylonitrile-styrene-butadiene rubber | 1.0 | Ethyl propionate | 4.0 | (1-1) | 2.0 | 75 | 77 |
| Comparative Example 9 | Acrylonitrile-styrene-butadiene rubber | 1.0 | Ethyl propionate | 4.0 | - | - | 69 | 70 |

Table 3 shows the configurations and evaluation results of the batteries of Examples 2 and 9 to 12 and Comparative Example 8.

TABLE 3

| | Binder | | Electrolytic solution | | | | Load characteristic s [%] | Cycle characteristi cs [%] | High-temperature storage characteristics [%] |
|---|---|---|---|---|---|---|---|---|---|
| | Type | Content [mass%] | Propioni c acid ester | FEC Conten t [mass% ] | Cyclic sulfuric acid anhydrid e | Cyclic sulfuric acid anhydride Content [mass%] | | | |
| Example 9 | Acrylonitrile-styrene-butadiene rubber | 1.0 | Ethyl propiona te | 2.0 | (1-1) | 0.5 | 82 | 79 | 3.5 |
| Example 2 | Acrylonitrile-styrene-butadiene rubber | 1.0 | Ethyl propiona te | 4.0 | (1-1) | 0.5 | 80 | 82 | 3.7 |
| Example 10 | Acrylonitrile-styrene-butadiene rubber | 1.0 | Ethyl propiona te | 6.0 | (1-1) | 0.5 | 77 | 84 | 4.3 |
| Example 11 | Acrylonitrile-styrene-butadiene rubber | 1.0 | Ethyl propiona te | 1.0 | (1-1) | 0.5 | 72 | 78 | 3.4 |
| Example 12 | Acrylonitrile-styrene-butadiene rubber | 1.0 | Ethyl propiona te | 7.0 | (1-1) | 0.5 | 76 | 84 | 7.2 |
| Comparativ e Example 8 | Acrylonitrile-styrene-butadiene rubber | 1.0 | Ethyl propiona te | - | (1-1) | 0.5 | 71 | 59 | - |

Table 4 shows the configurations and evaluation results of the batteries of Examples 2 and 13 to 26 and Comparative Example 9.

TABLE 4

| | Binder | | Electrolytic solution | | | | Load characteristics [%] | Cycle characteristics [%] |
|---|---|---|---|---|---|---|---|---|
| | Type | Content [mass%] | Propionic acid ester | FEC Content [mass%] | Cyclic sulfuric acid anhydride | Cyclic sulfuric acid anhydride Content [mass%] | | |
| Example 2 | Acrylonitrile-styrene-butadiene rubber | 1.0 | Ethyl propionate | 4.0 | (1-1) | 0.5 | 80 | 82 |
| Example 13 | Acrylonitrile-styrene-butadiene rubber | 1.0 | Ethyl propionate | 4.0 | (1-2) | 0.5 | 80 | 81 |
| Example 14 | Acrylonitrile-styrene-butadiene rubber | 1.0 | Ethyl propionate | 4.0 | (1-3) | 0.5 | 79 | 80 |
| Example 15 | Acrylonitrile-styrene-butadiene rubber | 1.0 | Ethyl propionate | 4.0 | (1-4) | 0.5 | 80 | 81 |
| Example 16 | Acrylonitrile-styrene-butadiene rubber | 1.0 | Ethyl propionate | 4.0 | (1-5) | 0.5 | 78 | 79 |
| Example 17 | Acrylonitrile-styrene-butadiene rubber | 1.0 | Ethyl propionate | 4.0 | (1-6) | 0.5 | 79 | 79 |
| Example 18 | Acrylonitrile-styrene-butadiene rubber | 1.0 | Ethyl propionate | 4.0 | (1-7) | 0.5 | 80 | 78 |
| Example 19 | Acrylonitrile-styrene-butadiene rubber | 1.0 | Ethyl propionate | 4.0 | (1-8) | 0.5 | 79 | 80 |
| Example 20 | Acrylonitrile-styrene-butadiene rubber | 1.0 | Ethyl propionate | 4.0 | (1-9) | 0.5 | 79 | 77 |
| Example 21 | Acrylonitrile-styrene-butadiene rubber | 1.0 | Ethyl propionate | 4.0 | (2-1) | 0.5 | 77 | 80 |
| Example 22 | Acrylonitrile-styrene-butadiene rubber | 1.0 | Ethyl propionate | 4.0 | (2-2) | 0.5 | 78 | 79 |
| Example 23 | Acrylonitrile-styrene-butadiene rubber | 1.0 | Ethyl propionate | 4.0 | (2-3) | 0.5 | 80 | 80 |
| Example 24 | Acrylonitrile-styrene-butadiene rubber | 1.0 | Ethyl propionate | 4.0 | (2-4) | 0.5 | 80 | 80 |
| Example 25 | Acrylonitrile-styrene-butadiene rubber | 1.0 | Ethyl propionate | 4.0 | (2-5) | 0.5 | 79 | 78 |
| Example 26 | Acrylonitrile-styrene-butadiene rubber | 1.0 | Ethyl propionate | 4.0 | (2-6) | 0.5 | 80 | 78 |
| Comparative Example 9 | Acrylonitrile-styrene-butadiene rubber | 1.0 | Ethyl propionate | 4.0 | - | - | 69 | 70 |

Table 5 shows the configurations and evaluation results of the batteries of Examples 2 and 27 to 38 and Comparative Examples 10 to 12.

TABLE 5

| | Binder | | Electrolytic solution | | | | | Load characteristics [4] | Cycle characteristics [&] | High-temperature storage characteristics [%] |
|---|---|---|---|---|---|---|---|---|---|---|
| | Type | Content [mass%] | Propionic acid ester | Blending ratio | FEC Content [mass%] | Cyclic sulfuric acid anhydride | Cyclic sulfuric acid anhydride Content [mass%] | | | |
| Example 27 | Acrylonitrile-styrene-butadiene rubber | 1.0 | Methyl propionate | 100 | 4.0 | (1-1) | 0.5 | 83 | 79 | 4.2 |
| Example 2 | Acrylonitrile-styrene-butadiene rubber | 1.0 | Ethyl propionate | 100 | 4.0 | (1-1) | 0.5 | 80 | 82 | 3.7 |
| Example 28 | Acrylonitrile-styrene-butadiene rubber | 1.0 | Propyl propionate | 100 | 4.0 | (1-1) | 0.5 | 79 | 82 | 3.4 |
| Example 29 | Acrylonitrile-styrene-butadiene rubber | 1.0 | Butyl propionate | 100 | 4.0 | (1-1) | 0.5 | 75 | 78 | 3.3 |
| Example 30 | Acrylonitrile-styrene-butadiene rubber | 1.0 | Methyl propionate Ethyl propionate | 10 90 | 4.0 | (1-1) | 0.5 | 85 | 80 | 4.1 |
| Example 31 | Acrylonitrile-styrene-butadiene rubber | 1.0 | Methyl propionate Ethyl propionate | 50 50 | 4.0 | (1-1) | 0.5 | 83 | 80 | 4.0 |
| Example 32 | Acrylonitrile-styrene-butadiene rubber | 1.0 | Methyl propionate Ethyl propionate | 90 10 | 4.0 | (1-1) | 0.5 | 80 | 81 | 3.8 |
| Example 33 | Acrylonitrile-styrene-butadiene rubber | 1.0 | Ethyl propionate Propyl propionate | 10 90 | 4.0 | (1-1) | 0.5 | 80 | 82 | 3.4 |
| Example 34 | Acrylonitrile-styrene-butadiene rubber | 1.0 | Ethyl propionate Propyl propionate | 50 50 | 4.0 | (1-1) | 0.5 | 80 | 81 | 3.3 |
| Example 35 | Acrylonitrile-styrene-butadiene rubber | 1.0 | Ethyl propionate Propyl propionate | 90 10 | 4.0 | (1-1) | 0.5 | 79 | 80 | 3.3 |
| Example 36 | Acrylonitrile-styrene-butadiene rubber | 1.0 | Propyl propionate Butyl propionate | 10 90 | 4.0 | (1-1) | 0.5 | 79 | 82 | 3.4 |
| Example 37 | Acrylonitrile-styrene-butadiene rubber | 1.0 | Propyl propionate Butyl propionate | 50 50 | 4.0 | (1-1) | 0.5 | 77 | 80 | 3.3 |
| Example 38 | Acrylonitrile-styrene-butadiene rubber | 1.0 | Propyl propionate Butyl propionate | 90 10 | 4.0 | (1-1) | 0.5 | 76 | 79 | 3.3 |
| Comparative Example 10 | Acrylonitrile-styrene-butadiene rubber | 1.0 | DMC | 100 | 4.0 | (1-1) | 0.5 | 70 | 64 | 18.4 |
| Comparative Example 11 | Acrylonitrile-styrene-butadiene rubber | 1.0 | EMC | 100 | 4.0 | (1-1) | 0.5 | 62 | 62 | 16.5 |
| Comparative Example 12 | Acrylonitrile-styrene-butadiene rubber | 1.0 | DEC | 100 | 4.0 | (1-1) | 0.5 | 55 | 71 | 13.4 |

The following can be seen from Table 1.

As in Examples 1 to 4, (1) the negative electrode active material layer contains acrylonitrile-styrene-butadiene rubber in an amount of 0.5 mass% or more and 2.0 mass% or less, (2) the non-aqueous electrolytic solution contains a propionic acid ester, and (3) the non-aqueous electrolytic solution further contains a halogenated cyclic carbonic acid ester (FEC) and a cyclic sulfuric acid anhydride, so that high load characteristics and cycle characteristics can be obtained.

As in Comparative Example 1, when the content of the acrylonitrile-styrene-butadiene rubber in the negative electrode active material layer is less than 0.5 mass%, cycle characteristics are deteriorated. This degradation of the characteristics is caused by the following reason. That is, since the content of the acrylonitrile-styrene-butadiene rubber in the negative electrode active material layer is insufficient, the negative electrode active material layer cannot withstand expansion and shrinkage of graphite during a charge-discharge cycle, and the negative electrode active material layer is disintegrated. Along with this, SEI derived from the cyclic sulfuric acid anhydride is disintegrated, and consumption of the halogenated cyclic carbonic acid ester (FEC) and the propionic acid ester is accelerated and depleted on the graphite surface exposed from SEI.

As in Comparative Example 2, when the amount of the acrylonitrile-styrene-butadiene rubber in the negative electrode active material layer exceeds 2.0 mass%, an increase in resistance due to coating with the acrylonitrile-styrene-butadiene rubber becomes large, and load characteristics are deteriorated.

As in Comparative Examples 3 to 6, when styrene-butadiene rubber not containing acrylonitrile is used as a binder, the consumption amount of the halogenated cyclic carbonic acid ester (FEC) increases, and cycle characteristics are deteriorated. Since the binding force of the binder decreases, the electron transfer resistance between the current collectors and between the active material particles in the negative electrode active material layer increases, and the load characteristics are deteriorated.

As in Comparative Example 7, when diethyl carbonate (DEC) is used as a non-aqueous solvent instead of the propionic acid ester, load characteristics and cycle characteristics are deteriorated. DEC is an advantageous material for reductive decomposition on the negative electrode as compared with ethyl propionate used in Examples 1 to 4, but since the ionic conductivity of the electrolytic solution is greatly reduced, when DEC is used as a non-aqueous solvent, load characteristics and cycle characteristics are deteriorated as described above.

As in Comparative Example 8, when the non-aqueous electrolytic solution does not contain a halogenated cyclic carbonic acid ester (FEC), the acrylonitrile-styrene-butadiene rubber alone is insufficient in the function of suppressing the reaction against the reductive decomposition of the propionic acid ester during a charge-discharge cycle, so that cycle characteristics are deteriorated.

As in Comparative Example 9, when the non-aqueous electrolytic solution does not contain a cyclic sulfuric acid anhydride, a low-resistance film derived from the cyclic sulfuric acid anhydride is not formed on the negative electrode, so that load characteristics are deteriorated. Since the film derived from the cyclic sulfuric acid anhydride also has a function of controlling the consumption amount of the halogenated cyclic carbonic acid ester (FEC), when the film is not formed on the negative electrode, cycle characteristics are also deteriorated.

The following can be seen from Table 2.

In Examples 2 and 5 to 8 in which the non-aqueous electrolytic solution contains a cyclic sulfuric acid anhydride, load characteristics and cycle characteristics are improved as compared with Comparative Example 9 in which the non-aqueous electrolytic solution does not contain a cyclic sulfuric acid anhydride. From the viewpoint of improving both load characteristics and cycle characteristics, the content of the cyclic sulfuric acid anhydride in the non-aqueous electrolytic solution is preferably 0.1 mass% or more and 1.0 mass% or less and more preferably 0.5 mass% or more and 1.0 mass% or less.

The following can be seen from Table 3.

In Examples 2 and 9 to 12 in which the non-aqueous electrolytic solution contains a halogenated cyclic carbonic acid ester (FEC), load characteristics and cycle characteristics are improved as compared with Comparative Example 8 in which the non-aqueous electrolytic solution does not contain a halogenated cyclic carbonic acid ester (FEC). From the viewpoint of improving both load characteristics and cycle characteristics and improving high-temperature storage characteristics, the content of the halogenated cyclic carbonic acid ester (FEC) in the non-aqueous electrolytic solution is preferably 2.0 mass% or more and 6.0 mass% or less.

The following can be seen from Table 4.

In Examples 2 and 13 to 26 in which the non-aqueous electrolytic solution contains cyclic sulfuric acid anhydrides represented by Formulas (1-1) to (1-9) and (2-1) to (2-6), load characteristics and cycle characteristics can be improved as compared with Comparative Example 9 in which the non-aqueous electrolytic solution does not contain a cyclic sulfuric acid anhydride. Therefore, by using at least one of the cyclic sulfuric acid anhydride (1) and the cyclic sulfuric acid anhydride (2), load characteristics and cycle characteristics can be improved.

The following can be seen from Table 5.

In Examples 2 and 27 to 29 in which the non-aqueous electrolytic solution contains various propionic acid esters each having different number of carbon atoms as a non-aqueous solvent, load characteristics and cycle characteristics can be improved as compared with Comparative Examples 10 to 12 in which the non-aqueous electrolytic solution contains a chain carbonic acid ester as an additive. This is because the chain carbonic acid ester is superior to the propionic acid ester in terms of reduction resistance on the negative electrode, but the non-aqueous electrolytic solution containing a propionic acid ester is superior to the non-aqueous electrolytic solution containing a chain carbonic acid ester in terms of ionic conductivity of the non-aqueous electrolytic solution.

Since the carbonic acid ester is decomposed and CO₂ is desorbed, Comparative Examples 10 to 12 in which the non-aqueous electrolytic solution contains a chain carbonic acid ester are deteriorated as compared with Examples 2 and 27 to 29 in which the non-aqueous electrolytic solution contains a propionic acid ester.

In Examples 30 to 38 containing a plurality of types of propionic acid esters each having different number of carbon atoms, regardless of the blending ratio of the plurality of types of propionic acid esters, load characteristics and cycle characteristics can be improved as compared with Comparative Examples 10 to 12 containing an additive other than the propionic acid ester as an additive of the non-aqueous electrolytic solution.

In the foregoing, one or more embodiments of the present application have been described; however, the present application is not limited thereto, and various modifications thereof may be made.

For example, the configurations, the methods, the steps, the shapes, the materials, the numerical values, and the like exemplified in the embodiments are merely examples, and configurations, methods, steps, shapes, materials, numerical values, and the like that are different from these examples, may be employed as necessary.

The configurations, methods, steps, shapes, materials, and numerical values of the above embodiments described above can be combined with each other according to an embodiment.

In the numerical range described in stages in the above embodiment, the upper limit value or the lower limit value of the numerical range in a certain stage may be replaced with the upper limit value or the lower limit value of the numerical range in another stage.

The materials described herein can be used singly or in combination of two or more, unless otherwise specified, according to an embodiment.

### DESCRIPTION OF REFERENCE SYMBOLS

10: Exterior material
11: Positive electrode lead
12: Negative electrode lead
13: Adhesive film
20: Electrode body
21: Positive electrode
21A: Positive electrode current collector
21B: Positive electrode active material layer
22: Negative electrode
22A: Negative electrode current collector
22B: Negative electrode active material layer
23: Separator
24: Protection tape
300: Battery pack
400: Electronic device

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A non-aqueous electrolyte secondary battery comprising:
a positive electrode;
a negative electrode; and
a non-aqueous electrolytic solution, wherein
the negative electrode includes a negative electrode active material layer including acrylonitrile-styrene-butadiene rubber,
the non-aqueous electrolytic solution includes a propionic acid ester, a halogenated cyclic carbonic acid ester, and at least one of cyclic sulfuric acid anhydrides represented by Chemical Formulas (1) and (2) below, and
a content of the acrylonitrile-styrene-butadiene rubber in the negative electrode active material layer is 0.5 mass% or more and 2.0 mass% or less,
[Chemical Formula 1] 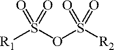
wherein R₁ and R₂ are each independently a divalent hydrocarbon group or divalent halogenated hydrocarbon group that may have a substituent, and R₁ and R₂ are bonded to each other, 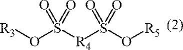
wherein R₃ and R₅ are each independently a divalent hydrocarbon group or divalent halogenated hydrocarbon group that may have a substituent, R₄ is a divalent hydrocarbon group or divalent halogenated hydrocarbon group that may have a substituent, and R₃ and R₅ are bonded to each other.

2. The non-aqueous electrolyte secondary battery according to claim 1, wherein a content of the cyclic sulfuric acid anhydride in the non-aqueous electrolytic solution is 0.1 mass% or more and 1.0 mass% or less.

3. The non-aqueous electrolyte secondary battery according to claim 1, wherein a content of the halogenated cyclic carbonic acid ester in the non-aqueous electrolytic solution is 2.0 mass% or more and 6.0 mass% or less.

4. The non-aqueous electrolyte secondary battery according to claim 1, wherein the propionic acid ester has 4 or more and 7 or less carbon atoms.
